(19) United States
(12) Patent Application Publication
(10) Pub. No.: US 2022/0187080 A1
(43) Pub. Date: Jun. 16, 2022

(54) INFORMATION PROCESSING DEVICE, INFORMATION PROCESSING SYSTEM, AND PROGRAM

(71) Applicant: TOYOTA JIDOSHA KABUSHIKI KAISHA, Toyota-shi (JP)

(72) Inventors: Masato EHARA, Gotemba-shi (JP); Kazuhiro SHIMIZU, Sunto-gun (JP); Satoshi TANABE, Mishima-shi (JP); Nanae TAKADA, Susono-shi (JP); Naohiro SEO, Sunto-gun (JP)

(73) Assignee: TOYOTA JIDOSHA KABUSHIKI KAISHA, Toyota-shi (JP)

(21) Appl. No.: 17/475,789

(22) Filed: Sep. 15, 2021

(30) Foreign Application Priority Data
Dec. 15, 2020 (JP) 2020-207938

(51) Int. Cl. G01C 21/34; G06N 20/00; G01C 21/36

(52) U.S. Cl. CPC G01C 21/3415; G01C 21/3661; G06N 20/00

(57) ABSTRACT

A processor acquires path information and stores the path information in a storage unit, determines whether or not the moving body is in a lost state based on the path information from the storage unit, and generates and outputs route information that guides the moving body to a predetermined place when the moving body is determined to be in the lost state. The processor acquires the path information as an input parameter, inputs the path information to a determination learning model, and outputs whether or not the moving body is in the lost state as an output parameter. The model is a learning model generated by machine learning using an input and output data set in which path information is used as an input parameter for learning and a determination result of whether or not path information is in the lost state is used as an output parameter for learning.

### CROSS-REFERENCE TO RELATED APPLICATION

This application claims priority to Japanese Patent Application No. 2020-207938 filed on Dec. 15, 2020, incorporated herein by reference in its entirety.

### BACKGROUND

### 1. Technical Field

The present disclosure relates to an information processing device, an information processing system, and a program.

### 2. Description of Related Art

Japanese Unexamined Patent Application Publication No. 2018-005308 discloses a technique in which when a wanderer is detected in a predetermined region inside a building, an utterance to the detected wanderer is output by at least one of voice or video to determine whether or not the wanderer forgets an initial intention that leads the wanderer to a start of wandering, based on an elapsed time from a start of a dialogue with the wanderer, and an utterance for guiding the wanderer to a predetermined guidance place is output by at least one of voice or video when determination is made that the wanderer forgets the initial intention.

### SUMMARY

In the related art, a method of guiding a driver to a predetermined place while respecting the intention of the driver has not been studied. Therefore, there has been a demand for a technique that enables the driver to arrive at the predetermined place without going missing, while continuing to drive, even though when the driver gets lost while driving a moving body, such as a vehicle.

The present disclosure has been made in view of the above and provides an information processing device, an information processing system, and a program that enable a driver to arrive at a predetermined place without going missing, while continuing to drive, even though the driver gets lost while driving a moving body.

A first aspect of the disclosure relates to an information processing device including a processor configured to have hardware. The processor acquires path information including information on a movement path of a moving body driven by a driver, determines whether or not the moving body is in a lost state set in advance based on the path information, and generates and outputs route information that guides the moving body to a predetermined place when the moving body is determined to be in the lost state.

A second aspect of the disclosure relates to an information processing system including a first device having a first processor configured to have hardware, which is provided in a moving body driven by a driver and acquires, from the moving body, and outputs moving body information about the moving body, path information about movement of the moving body, and user information about the driver, and a second device having a second processor configured to have hardware, which acquires path information including information on a movement path of the moving body from the first device, determines whether or not the moving body is in a lost state set in advance based on the path information, and generates route information that guides the moving body to a predetermined place and outputs the route information to the first device when the moving body is determined to be in the lost state.

A third aspect of the disclosure relates to a program causing a processor with hardware to execute acquiring path information including information on a movement path of a moving body driven by a driver, determining whether or not the moving body is in a lost state set in advance based on the path information, and generating and outputting route information that guides the moving body to a predetermined place when the moving body is determined to be in the lost state.

According to the present disclosure, it is possible for a driver to arrive at a predetermined place without going missing, while continuing to drive, even though the driver gets lost while driving a moving body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a traveling management system according to one embodiment; and

FIG. 2 is a flowchart for describing a traveling management method in the traveling management system according to one embodiment.

### DETAILED DESCRIPTION OF EMBODIMENTS

Hereinafter, an embodiment of the present disclosure will be described with reference to drawings. In all the drawings of the following embodiments, the same reference numeral is assigned to the same or corresponding part. The present disclosure is not limited to the embodiments described below.

According to findings of the present discloser, there is a technique in which when a wanderer is detected in a predetermined region, an utterance to the wanderer is output by a voice or a video, and the wanderer is guided to a predetermined guidance place when determination is made that the wanderer forgets an initial intention based on an elapsed time from a start of the dialogue with the wanderer. In this technique, a method of guiding a driver of a vehicle to the predetermined place while respecting the intention of the driver has not been studied. Therefore, it is difficult to guide the driver to the planned place without causing a missing or traffic accident, while continuing to drive. The present disclosure supports the thinking of the driver in addition to the movement using a mobility device by the driver such as an elderly person. In other words, the driver may get lost or the like while driving the vehicle. In this case, a movement range or a movement direction is restricted to guide the driver to the predetermined place and thus the going missing is suppressed, while continuing to drive. Specifically, the present discloser devises a method in which an information processing device learns behavior of the vehicle, and starts support to guide the driver to the predetermined place when the vehicle driven by the driver is determined to be in a wandering state or sets a limit on a driving time such that the driver does not get tired of the driving when the driver is the elderly person. One embodiment described below is based on the above ideas.

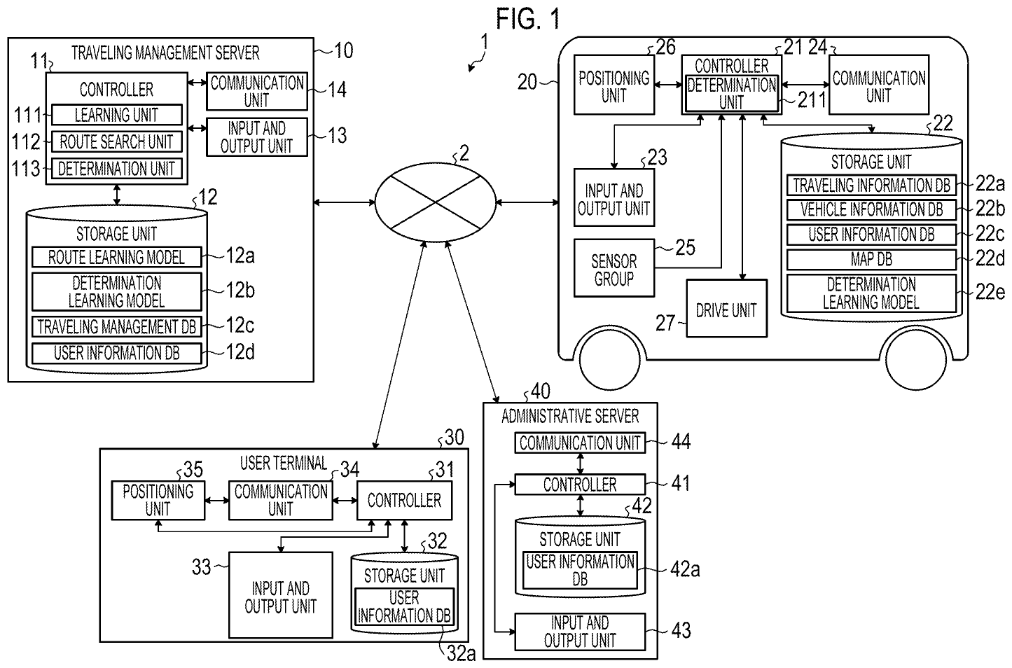

First, a traveling management system to which the information processing device according to one embodiment of the present disclosure can be applied will be described. FIG. 1 is a schematic diagram showing a traveling management system 1 according to the present embodiment. As shown in FIG. 1, the traveling management system 1 according to the present embodiment has a traveling management server 10, a vehicle 20, a user terminal 30, and an administrative server 40 capable of communicating with each other through a network 2. In the following description, information is transmitted and received between the respective components through the network 2, but a description of this point each time will be omitted.

The network 2 is configured of an internet network, a mobile phone network, or the like. The network 2 is, for example, a public communication network, such as the Internet, and may include another communication network, such as a wide area network (WAN), a telephone communication network, such as a mobile phone, or a wireless communication network, such as WiFi (registered trademark).

Traveling Management Server

The traveling management server 10 as an information processing device configured to manage traveling of the vehicle 20 manages the traveling of the vehicle 20. The traveling management server 10 as a second device has a general computer configuration capable of communicating through the network 2. The traveling management server 10 includes a controller 11, a storage unit 12, an input and output unit 13, and a communication unit 14.

In the present embodiment, various types of information such as vehicle information, traveling information, and user information are supplied to the traveling management server 10 from each vehicle 20 at a predetermined timing. The vehicle information as moving body information includes vehicle identification information and sensor information. The sensor information includes energy remaining amount information related to a remaining energy amount such as a fuel remaining amount of the vehicle 20 or a battery charging amount (state of charge: SOC), or information such as speed information and acceleration information, sensed by the vehicle 20 using a sensor group 25. However, the sensor information is not necessarily limited to these pieces of information. The traveling information as movement information includes information about the traveling such as a traveling path as a movement path of the vehicle 20 or position information. However, the traveling information is not necessarily limited to these pieces of information. The user information includes user identification information, user selection information, and personal information. However, the user information is not necessarily limited to these pieces of information. An example of the user identification information includes information for identifying users such as the driver or a protector of the driver from each other. The user selection information includes various types of information input or selected by the user. An example of user state information includes information indicating a state of the user. Examples of the personal information include some of various pieces of information such as access fields such as name, age, address, date of birth, age, presence or absence of lover, presence or absence of spouse, place of employment (work history), school name (educational background), and hobby, behavioral pattern information, and held qualification, as information about the user.

Specifically, the controller 11 having hardware configured to manage the traveling includes a processor, such as a central processing unit (CPU), a digital signal processor (DSP), or a field-programmable gate array (FPGA), and a main storage unit, such as a random access memory (RAM) or a read only memory (ROM).

The storage unit 12 is configured of a storage medium selected from an erasable programmable ROM (EPROM), a hard disk drive (HDD), a removable medium, and the like. An example of the removable medium includes a universal serial bus (USB) memory or a disc recording medium, such as a compact disc (CD), a digital versatile disc (DVD), or a Blu-ray (registered trademark) disc (BD). The storage unit 12 can store various programs, various tables, various databases, and the like, such as an operating system (OS), a route learning model 12a, a determination learning model 12b, a traveling management database 12c, and a user information database 12d.

The controller 11 as a second processor having hardware can load and execute the program stored in the storage unit 12 into a work region of a main storage unit to realize functions of a learning unit 111, a route search unit 112, and a determination unit 113 through the execution of the program. The program includes a learning model generated by machine learning such as a route learning model 12a or a determination learning model 12b. The learning model is also referred to as a learned model, a model, or the like. The learning model can be generated by machine learning, such as deep learning using a neural network, with an input and output data set of predetermined input and output parameters as teacher data. Accordingly, the controller 11 can realize the functions of the learning unit 111, the route search unit 112, and the determination unit 113.

The route search unit 112 of the controller 11 can search a traveling route of the vehicle 20 from the traveling information, the vehicle information, and the user information of a predetermined vehicle 20 by the route learning model 12a stored in the storage unit 12. A method of generating the route learning model 12a, which is a program stored in the storage unit 12, will be described.

In the present embodiment, the function of the learning unit 111 is executed by executing the program by the controller 11. The learning unit 111 can generate the route learning model 12a with the input and output data set, as the teacher data, in which the personal information of the user information related to a plurality of users and the position information of the traveling information are used as input parameters for learning and a movable range or a movable direction based on the position information included in the traveling information when each of the users drives the vehicle 20 and a predetermined place and a drivable time based on the personal information of the users are used as output parameters for learning. The predetermined place can be set to any place close to a place where the vehicle 20 is determined to be in a lost state.

The learning unit 111 may make a learning model that outputs the drivable time independent and generate a driving time learning model that outputs the drivable time for each user. That is, the driving time learning model may be generated separately with the input and output data set, as the teacher data, in which the personal information about the users is used as the input parameter for learning and the drivable time when each of the users drives the vehicle 20 is used as the output parameter for learning.

The learning unit 111 performs the machine learning based on the input and output data set acquired by the traveling management server 10. The learning unit 111 writes the learned result as the route learning model 12a in the storage unit 12 and stores the result. The route learning model 12a is a learning model that searches for and generates the traveling route based on the user information of the user, who is the driver of the vehicle 20, and the traveling information and position information of the vehicle 20. That is, the route search unit 112 executes a function of generating and outputting the traveling route of the vehicle 20 by executing the route learning model 12a, which is a program. It is also possible to execute traveling route search processing according to a rule base, instead of the route learning model 12a.

The controller 11 can determine whether or not the vehicle 20 is in the lost state from the traveling information including path information of the traveling path of the vehicle 20 by the determination learning model 12b stored in the storage unit 12. A method of generating the determination learning model 12b, which is a program stored in the storage unit 12, will be described.

The learning unit 111 can generate the determination learning model 12b with the input and output data set, as the teacher data, in which the traveling information including the information of the traveling path by a plurality of vehicles 20 is used as the input parameter for learning and the determination result of whether or not each of the traveling paths of the vehicles 20 is in the lost state is used as the output parameter for learning. That is, the learning unit 111 can generate the determination learning model 12b with the input and output data set, as the teacher data, in which the information of the traveling path included in the traveling information is used as the input parameter for learning and the result of determining whether or not the vehicle is in the lost state for each traveling path is in the lost state is used as the output parameter for learning. An example of the lost state specifically includes a state in which the traveling path is in a direction or a path different from a direction or a path toward a destination when the destination is set in a car navigation system. An example of the lost state specifically includes a state in which the traveling path is substantially the same path a plurality of times when the destination is not set in the car navigation system. In the present embodiment, the lost state can be defined and set in advance when the teacher data is generated. That is, data labeled whether or not the vehicle is in the lost state is created for various traveling paths, and can be used as the output parameter for learning as the result of determining whether or not the vehicle is in the lost state for each traveling path.

The learning unit 111 performs the machine learning based on the input and output data set acquired by the traveling management server 10. The determination learning model 12b is a learning model that determines whether or not the traveling path of the vehicle 20 is in the lost state based on the traveling information of the vehicle 20. The learning unit 111 writes the learned result in the storage unit 12 and stores the result. The determination unit 113 executes a function of determining whether or not the vehicle 20 is in the lost state by executing the program by the controller 11, that is, the determination learning model 12b. It is also possible to execute determination processing according to the rule base, instead of the determination learning model 12b.

The learning unit 111 may store, at a predetermined timing, the latest learning model at this timing in the storage unit 12 separately from the neural network performing the learning. When the latest learning model is stored in the storage unit 12, updating of deleting an old learning model and storing the latest learning model may be performed, or accumulating of storing the latest learning model while a part or all of the old learning model is stored may be performed. The various programs also include a model update processing program. The learning model is also referred to as a learned model or a model. It is also possible to execute processing according to the rule base, instead of the learning model.

The storage unit 12 stores a traveling management database 12c in which various types of data are stored in a searchable manner and a user information database 12d. The traveling management database 12c and the user information database 12d are, for example, relational databases (RDB). The database (DB) described below is constructed by a program of a database management system (DBMS), executed by the processor, configured to manage the data stored in the storage unit 12. In the traveling management database 12c, the vehicle identification information of the vehicle information and another piece of information such as the traveling information are associated with each other and stored in a searchable manner. When the traveling management server 10 communicates with the user terminal 30, unique user identification information for identifying the user terminal 30 and the user selection information input to the user terminal 30 by the user can also be associated with each other and stored in the traveling management database 12c or the user information database 12d.

The vehicle identification information assigned to an individual vehicle 20 is stored in the traveling management database 12c in a searchable state. The vehicle identification information includes various types of information for identifying the individual vehicle 20 from each other, and includes information requested for accessing the traveling management server 10 when information related to the vehicle 20 is transmitted. The vehicle identification information is also transmitted when the vehicle 20 transmits the various types of information. When the vehicle 20 transmits predetermined information such as the vehicle information or the traveling information to the traveling management server 10 together with the vehicle identification information, the traveling management server 10 associates the predetermined information with the vehicle identification information and stores the associated information within the traveling management database 12c in a searchable state. Similarly, the user identification information includes various types of information for identifying an individual user including the driver from each other. The user identification information is, for example, a user ID capable of identifying an individual user terminal 30 or the driver of the vehicle 20, and includes information requested for accessing the traveling management server 10 when information related to the driver or the user terminal 30 is transmitted. When the vehicle 20 or the user terminal 30 transmits the predetermined information such as the user selection information to the traveling management server 10 together with the user identification information, the traveling management server 10 associates the predetermined information with the user identification information and stores the associated information within the traveling management database 12c of the storage unit 12 in a searchable state.

The input and output unit 13 may be configured of, for example, a touch panel display, a speaker microphone, a button, a switch, a jog dial, and the like. The input and output unit 13 as an output unit is configured to notify the outside of the predetermined information by displaying a character, a figure, or the like on a screen of a display, such as a liquid crystal display, an organic EL display, or a plasma display, or outputting a voice from the speaker, according to the control by the controller 11. The input and output unit 13 includes a printer configured to output the predetermined information by performing printing on printing paper or the like. The various types of information stored in the storage unit 12 can be confirmed, for example, on a display of the input and output unit 13 installed in a predetermined office or the like. The input and output unit 13 as an input unit is, for example, configured by selecting from a touch panel keyboard incorporated inside a keyboard or the input and output unit 13 to detect a touch operation of the display panel, a voice input device capable of making a call to the outside, a switch, or a jog dial. The inputting of the predetermined information from the input and output unit 13 of the traveling management server 10 enables the vehicle 20 to perform the traveling management remotely. Therefore, it is possible to easily manage the traveling of the vehicle 20.

The communication unit 14 is, for example, a local area network (LAN) interface board or a wireless communication circuit for wireless communication. The LAN interface board or the wireless communication circuit is connected to the network 2, such as the Internet, which is the public communication network. The communication unit 14 is connected to the network 2 and communicates with the vehicle 20, the user terminal 30, and the administrative server 40. The communication unit 14 receives the vehicle identification information, the vehicle information, or the traveling information which is unique to the vehicle 20 or transmits route information, various instruction signals, or a confirmation signal to the vehicle 20, with each vehicle 20. The communication unit 14 transmits information to the user terminal 30 owned by the driver when the vehicle 20 is used or receives the user identification information for identifying the driver from the user terminal 30 or the various types of information, with the user terminal 30.

Vehicle

A vehicle configured to travel by the driving of the driver can be employed as the vehicle 20, as the moving body. A semi-autonomous driving type vehicle 20 capable of performing autonomous traveling, in part of the traveling, according to a traveling command provided by the traveling management server 10, a predetermined program, or the like may be employed as the vehicle 20. A so-called elderly person, such as 60 years old or older or 65 years old or older, or a user having dementia or another disease can be assumed as the driver of the vehicle 20. However, the driver is not necessarily limited to the occupants. The vehicle 20 can be moved toward the destination desired by the user by operating a steering wheel or the like by the user who used the vehicle or the user who boarded the vehicle. In the present embodiment, a vehicle, such as an electric vehicle (EV), a plug-in hybrid vehicle (PHV), a fuel cell vehicle (FCV), a fuel cell electric vehicle (FCEV), or a compressed natural gas (CNG) vehicle, will be described as the vehicle 20. However, a moving body other than the vehicle may be employed, and the moving body includes a light vehicle, such as a two-wheeled vehicle, and another moving body on a road. That is, the present embodiment can be applied, as the moving body, to a motorcycle equipped with a motor and a battery, an electric two-wheeled vehicle, such as a bicycle or a kickboard, a three-wheeled vehicle, a bus, and a truck, for example.

The vehicle 20 includes a controller 21, a storage unit 22, an input and output unit 23, a communication unit 24, a sensor group 25, a positioning unit 26, and a drive unit 27. The controller 21, the storage unit 22, the input and output unit 23, and the communication unit 24 respectively have the same physical and functional configurations as the controller 11, the storage unit 12, the input and output unit 13, and the communication unit 14.

The controller 21 as a first processor having hardware integrally controls the operations of various components as a first device mounted on the vehicle 20. The controller 21 can further load and execute a program stored in the storage unit 22 into a work region of a main storage unit to realize a function of a determination unit 211 through the execution of the program. A determination learning model 22e stored in the storage unit 22 has substantially the same function as the determination learning model 12b of the traveling management server 10. Accordingly, the determination unit 211 has substantially the same function as the determination unit 113 of the traveling management server 10. The controller 21 can also execute a part of the functions of the traveling management server 10. That is, the controller 21 may include a learning unit or a route search unit in addition to the determination unit 211.

The storage unit 22 can store a traveling management database 22a, a vehicle information database 22b, a user information database 22c, a map database 22d, and a determination learning model 22e. The traveling management database 22a stores the traveling information related to the traveling of the vehicle 20 in an accumulatable or updatable manner. In the vehicle information database 22b, various types of information including the battery charging amount, the fuel remaining amount, a current position, and the like are stored in the updatable manner. The user information database 22c stores the user information including the personal information of the user about the user who is the driver of the vehicle 20 in an updatable, deletable, searchable manner. The map database 22d stores various types of map information.

The input and output unit 23 as an output unit is configured such that the predetermined information can be notified to the outside. The input and output unit 23 as an input unit is configured such that the driver or the like can input the predetermined information to the controller 21.

The communication unit 24 communicates with the traveling management server 10, the user terminal 30, and the administrative server 40 by wireless communication through the network 2.

The sensor group 25 may include a sensor related to the traveling of the vehicle 20, such as a vehicle speed sensor, an acceleration sensor, or a fuel sensor, a vehicle cabin sensor capable of detecting, for example, various situations inside a vehicle cabin or a vehicle cabin imaging camera, a vehicle external sensor capable of detecting various situations outside the vehicle cabin or a vehicle external imaging camera, or the like. The sensor information detected by the various sensors or cameras constituting the sensor group 25 is output to the controller 21 through a vehicle information network (control area network: CAN) configured of transmission lines connected to the various sensors. The sensor group 25 may include a wearable terminal worn by the driver or a passenger and detect vital information, such as a body temperature, pulse, brain wave, blood pressure, and sweating state of the occupant, to detect a state of the occupant.

The positioning unit 26 as a position information acquisition unit receives a radio wave from a GPS satellite by a global positioning system (GPS) sensor to detect a position of the vehicle 20. With a plurality of GPS sensors, the orientation accuracy of the vehicle 20 can be improved. The detected position and traveling path are stored in the traveling management database 22a in a searchable state as the position information or the traveling path information in the traveling information. A method of combining light detection and ranging or laser imaging detection and ranging (LiDAR) and a three-dimensional digital map may be employed as a method of detecting the position of the vehicle 20. The position information may be included in the vehicle information, and the position information of the vehicle 20 detected by the positioning unit 26 may be stored in the vehicle information database 22b.

The car navigation system is configured of the positioning unit 26, the map database 22d stored in the storage unit 22, and the input and output unit 23. In the car navigation system, the input and output unit 23 as a notification unit constitutes a display unit that displays image, video, and character information and a voice output unit that generates a sound, such as a voice or an alarm sound. The input and output unit 23 as the input unit receives the input of the operation of the user and outputs signals corresponding to various received operation contents to the controller 21. The car navigation system superimposes the current position of the vehicle 20 acquired by the positioning unit 26 on the map data stored in the map database 22d to notify the user such as the driver by the input and output unit 23 of information including a road on which the vehicle 20 is currently traveling, a path to the destination, and the like.

The drive unit 27 is a drive unit configured to drive the vehicle 20. Specifically, the vehicle 20 includes an engine and a motor as a drive source. The engine is configured to generate electricity using an electric motor or the like by being driven by fuel combustion. The generated power is charged into a rechargeable battery. The motor is driven by the battery. The vehicle 20 includes a drive transmission mechanism configured to transmit driving force of the engine or the motor, drive wheels configured to travel, and the like. The drive unit 27 differs depending on whether the vehicle 20 is the electric vehicle (EV), a hybrid vehicle (HV), the fuel cell vehicle (FCV), the compressed natural gas (CNG) vehicle, or the like, but detailed description thereof will be omitted.

User Terminal

The user terminal 30 as a use terminal can be operated by a user such as a protector, supervisor, or related person of the driver. The user terminal 30 is configured to transmit various types of information such as the user identification information, the user selection information, and the user information including the personal information to the traveling management server 10 or the administrative server 40 by a call using various programs and voices. The user terminal 30 is configured to receive various types of information from the traveling management server 10 or the administrative server 40.

The user terminal 30 includes a controller 31, a storage unit 32, an input and output unit 33, a communication unit 34, and a positioning unit 35, which are connected to each other in a communicable manner. The controller 31, the storage unit 32, the input and output unit 33, the communication unit 34, and the positioning unit 35 respectively have the same physical and functional configurations as the controller 11, the storage unit 12, the input and output unit 13, the communication unit 14, and the positioning unit 26. In the user terminal 30, the call to the outside includes, for example, a call with an operator or an artificial intelligence system resident in the traveling management server 10 or the administrative server 40, in addition to a call with another user terminal 30. The input and output unit 33 may be separately configured as an input unit and an output unit. Specifically, the user terminal 30 can employ a mobile phone, such as a smartphone, a notebook-type or tablet-type information terminal, or a notebook-type or desktop-type personal computer.

The controller 31 executes an operating system (OS) and various application programs stored in the storage unit 32 to integrally control the operations of the storage unit 32, the input and output unit 33, and the communication unit 34. The storage unit 32 is configured to store a user information database 32a. The user information database 32a can store the user information about the user who owns the user terminal 30 or the driver who drives the vehicle 20. The user who owns the user terminal 30 may be the related person of the driver of the vehicle 20, that is, a protector, a guardian, an observer, or the like. The communication unit 34 transmits and receives various types of information including the user information such as the user identification information, the user selection information, and the personal information to and from the traveling management server 10, the vehicle 20, the administrative server 40, and the like through the network 2.

Administrative Server

The administrative server 40 is a server managed by an administrative agency, such as the police or a government office. The administrative server 40 has a general computer configuration capable of communicating through the network 2 and includes a controller 41, a storage unit 42, an input and output unit 43, and a communication unit 44. The administrative server 40 receives various types of information such as the traveling information and the user information from the traveling management server 10, the vehicle 20, and the user terminal 30.

The controller 41, the storage unit 42, the input and output unit 43, and the communication unit 44 respectively have the same functional and physical configurations as the controller 11, the storage unit 12, the input and output unit 13, and the communication unit 14.

The storage unit 42 can store various programs, various tables, various databases, and the like, such as an OS and a user information database 42a. The controller 41 as a processor having hardware can load and execute a program stored in the storage unit 42 into a work region of a main storage unit to realize various functions through the execution of the program. In the user information database 42a, the user information acquired from the traveling management server 10, each vehicle 20, or each user terminal 30 is stored in association with the user identification information. The communication unit 44 is connected to the network 2 and communicates with the traveling management server 10, the vehicle 20, and the user terminal 30.

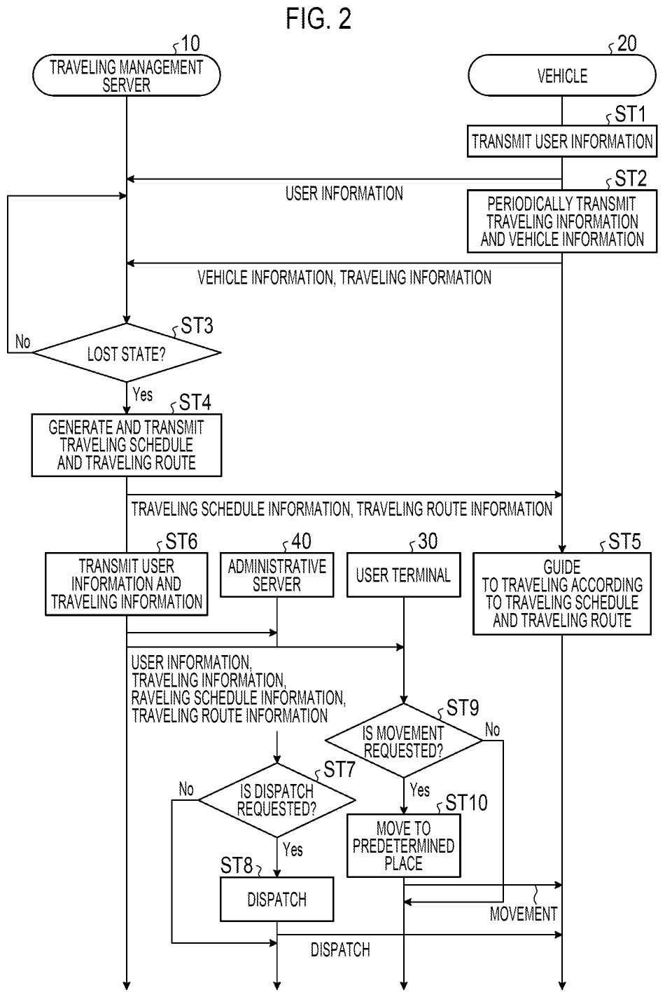

Next, a traveling management method executed by the traveling management system 1 according to the present embodiment will be described. FIG. 2 is a flowchart for describing the traveling management method according to the present embodiment. In the following description, the transmission and reception of the information is performed through the network 2 and the respective communication units 14, 24, 34, and 44, but a description of this point each time will be omitted. When the information is transmitted and received to and from each vehicle 20 and to and from each user terminal 30, the identification information for individually specifying the vehicle 20 or the user terminal 30 is also transmitted and received in association with the information to be transmitted and received. However, a description of this point each time will be omitted. The flowchart shown in FIG. 2 shows the processing related to the predetermined vehicle 20 and the user terminal 30 owned by the related person of the driver of the vehicle 20, and is executed by each of the vehicle 20 and the user terminal 30.

As shown in FIG. 2, first, in step ST1, the vehicle 20 travels on a road or an area, for example, in a predetermined region, such as a smart city, or around home of the driver. At this time, the controller 21 of the vehicle 20 transmits the user information including the personal information about the driver to the traveling management server 10. The controller 11 of the traveling management server 10 stores the received user information in the storage unit 12.

Subsequently, in step ST2, the controller 21 of the vehicle 20 periodically transmits the traveling information and the vehicle information to the traveling management server 10. The controller 11 of the traveling management server 10 stores the received traveling information and vehicle information in the traveling management database 12c by accumulating or updating.

Next, in step ST3, the determination unit 113 of the controller 11 in the traveling management server 10 inputs the traveling information acquired by the transmission from the vehicle 20 to the determination learning model 12b as the input parameter. The determination unit 113 outputs the determination information as to whether or not the traveling path included in the traveling information indicates the lost state, as the output parameter of the determination learning model 12b. The output parameter may be output as the probability of being in the lost state. Therefore, in this case, the vehicle 20 may be determined to be in the lost state when the probability of being in the lost state is equal to or larger than a predetermined probability.

When the determination unit 113 determines in step ST3 that the vehicle 20 is not in the lost state (step ST3: No), the controller 11 repeatedly executes the processing of steps ST2 and ST3. The determination of whether or not the vehicle 20 is in the lost state may be performed by the vehicle 20. That is, the processing of step ST3 may be executed by the determination unit 211 of the vehicle 20 using the determination learning model 22e.

When the determination unit 113 determines in step ST3 that the vehicle 20 is in the lost state (step ST3: Yes), the processing proceeds to step ST4. In step ST4, the route search unit 112 in the traveling management server 10 reads out the route learning model 12a and searches the traveling route of the vehicle 20 from the received traveling information, vehicle information, and user information of the vehicle 20. That is, the route search unit 112 inputs the personal information of the user information related to the driver of the vehicle 20 and the position information of the traveling information to the route search unit 112 as the input parameters. The route search unit 112 outputs the movable range or the movable direction when the driver drives the vehicle 20, and the predetermined place and the drivable time based on the personal information of the driver, as the output parameters of the route learning model 12a. That is, the route search unit 112 outputs the movable range or the movable direction, the predetermined place, and the drivable time.

The route search unit 112 generates traveling schedule information based on the movable range or the movable direction, the predetermined place, and the drivable time. That is, a traveling schedule is generated such that the driver does not continue to drive beyond the drivable time until the vehicle 20 is driven and arrives at a predetermined position, and transmitted to the vehicle 20 as the traveling schedule information. Similarly, the route search unit 112 generates traveling route information for the vehicle 20 to travel based on the movable range or the movable direction and the predetermined place. That is, a traveling route is generated to set the movable range or the movable direction for the driver of the vehicle 20 in the lost state and guide the driver to the predetermined place, and transmitted to the vehicle 20 as the traveling route information. When using the driving time learning model, the route search unit 112 may input the personal information about the driver of the vehicle 20 into the driving time learning model as the input parameter, and output the drivable time when the driver drives the vehicle 20 as the output parameter.

Next, the controller 21 of the vehicle 20 that has received the traveling schedule information and the traveling route information shifts to step ST5 to store the traveling schedule information and the traveling route information in the storage unit 22. The car navigation system of the vehicle 20 guides the driver of the vehicle 20 to travel to the predetermined place according to the traveling schedule and the traveling route read out from the storage unit 22. With the above, the traveling management processing according to the present embodiment ends.

On the other hand, in step ST6, in the traveling management server 10, the controller 11 transmits the user information about the driver and the traveling information of the vehicle 20 in the lost state to at least one of the user terminal 30 or the administrative server 40. In parallel, the controller 11 transmits the generated traveling schedule information and traveling route information to at least one of the user terminal 30 or the administrative server 40. The transmission of various types of information from the traveling management server 10 is executed to the user terminal 30 of the related person associated with the driver of the vehicle 20.

When the administrative server 40 receives the information from the traveling management server 10, the processing proceeds to step ST7. In step ST7, the controller 41 of the administrative server 40 specifies the driver of the vehicle 20 based on the received user information. The controller 41 determines whether or not the dispatch of an administrative officer, such as a police officer, is requested based on the specified driver and the received traveling information. When the controller 41 determines that the dispatch is not requested (step ST7: No), the processing by the administrative server 40 ends. When the controller 41 determines that dispatch is requested (step ST7: Yes), the processing proceeds to step ST8, and the administrative officer is dispatched to the predetermined place or a position where the vehicle 20 is present based on the position information and the traveling schedule information included in the traveling route information. An administrator or worker of the administrative server 40 may determine whether or not the dispatch is requested. In this case, when the dispatch is requested, information on the content that the dispatch is requested may be input from the input and output unit 43 and supplied to the controller 41. With the above, the traveling management processing according to the present embodiment ends.

On the other hand, when the user terminal 30 receives the information from the traveling management server 10, the processing proceeds to step ST9. In step ST9, the controller 31 of the user terminal 30 determines whether or not the user is requested to move based on the received user information and traveling information. The related person such as the protector or the supervisor who owns the user terminal 30 may perform the determination as to whether or not the movement is requested. In this case, the user selection information about the necessity of movement can be input from the input and output unit 33 and input to the controller 31. When the controller 31 determines that the movement is not requested or acquires unrequested user selection information (step ST9: No), the processing by the user terminal 30 ends. On the other hand, when the controller 31 determines that the movement is requested or acquires requested user selection information (step ST9: Yes), the processing proceeds to step ST10 and the user or the like who owns the user terminal 30 moves to the predetermined place which is the destination of the traveling route based on the position information and the traveling schedule information included in the traveling route information. The user who owns the user terminal 30 may move to the position where the vehicle 20 is present. With the above, the traveling management processing according to the present embodiment ends.

According to one embodiment of the present disclosure described above, in the moving body such as the vehicle 20 driven by an elderly person, the behavior of the vehicle 20 is learned to determine whether or not the vehicle 20 is in the lost state. When determination is made that the vehicle 20 is in the lost state, the traveling management server 10 starts support to guide the vehicle 20 to the predetermined place and restricts the movable range or movable direction of the vehicle 20 to guide the vehicle 20 to the predetermined place. Accordingly, even though the driver gets lost and is in the lost state while driving the vehicle 20, the driver can arrive at the predetermined place without going missing, while continuing to drive.

Further, according to one embodiment of the present disclosure, with the generation of the traveling schedule by setting the upper limit of the time for which the driver continuously drives based on the personal information of the driver, the driver can have time to take a break. Therefore, since accumulation of fatigue due to the driving can be reduced even though the driver is an elderly person, it is possible to suppress the occurrence of, for example, a traffic accident. Even though the driver is an elderly person or suffers from dementia, it is possible to guide the vehicle 20 to the predetermined place while respecting the intention of the driver. Furthermore, since the predetermined place can be shared with the related person of the driver by transmitting the predetermined place to the user terminal 30 owned by the related person such as the protector or supervisor of the driver, it is possible to reduce the possibility of the driver going missing. Further, since it is possible to contact the administration, such as the police, when determination is made that the vehicle 20 is in the lost state, it is possible to further ensure the safety of the driver.

Although the embodiments of the present disclosure have been specifically described above, the present disclosure is not limited to the above embodiments. Various modifications based on the technical idea of the present disclosure or an embodiment obtained by combining mutual embodiments can be employed. For example, the device configuration in the above embodiment is merely an example, and a device configuration different from the above may be used as needed.

For example, in the embodiment, the deep learning using the neural network is mentioned as an example of the machine learning, but machine learning based on other methods may be performed. Other supervised learning, such as support vector machine, decision tree, naive Bayes, and k-nearest neighbors algorithm, may be used. Semi-supervised learning may be used instead of the supervised learning.

Recoding Medium

In one embodiment of the present disclosure, a computer or another machine or device (hereinafter, referred to as computer or the like) can record, on a readable recording medium, the program capable of executing the processing method by the traveling management server 10, the vehicle 20, or the administrative server 40. The computer or the like reads and executes the program of the recording medium to function as the controllers of the traveling management server 10, the vehicle 20, or the administrative server 40. The recording medium readable by the computer or the like is a non-transitory recording medium in which the information, such as the data or the program, can be accumulated by electrical, magnetic, optical, mechanical, or chemical action and the computer or the like can read the information. Examples of a recording medium that can be removed from the computer or the like among such recording media include a flexible disk, a magneto-optical disk, a CD-ROM, a CD-R/W, a digital versatile disk (DVD), a BD, a DAT, a magnetic tape, and a memory card, such as a flash memory. Examples of a recording medium fixed to computers or the like include a hard disk and a ROM. Further, an SSD can be used as the recording medium that can be removed from the computer or the like or as the recording medium fixed to the computer or the like.

### Other Embodiments

In the traveling management server 10, the vehicle 20, the user terminal 30, and the administrative server 40 according to one embodiment, the “unit” can be read as a “circuit” or the like. For example, the communication unit can be read as a communication circuit.

The program to be executed by the traveling management server 10 or the administrative server 40 according to one embodiment may be stored on a computer connected to a network, such as the Internet, and provided by downloading through the network.

In the description of the flowchart in the present specification, the sequential relationship of the processing between steps has been clarified by using expressions such as “first”, “after”, and “subsequently”. However, the order of processing requested to implement the present embodiment is not uniquely defined by the expressions. That is, the order of processing in the flowchart described in the present specification can be changed within a consistent range.

An edge computing technique in which terminals capable of executing a part of the processing of the server can be disposed in a distributed manner in a place physically close to the information processing device to efficiently communicate a large amount of data and shorten an arithmetic processing time may be applied, instead of the system equipped with one server.

Further effects and modification examples can be easily derived by those skilled in the art. The broader aspects of the present disclosure are not limited to the specific details and representative embodiments represented and described above. Therefore, various changes can be made without departing from the spirit or scope of the general concept of the disclosure as defined by the accompanying claims and their equivalents.

What is claimed is:

1. An information processing device comprising a processor configured to have hardware,
wherein the processor is configured to
acquire path information including information on a movement path of a moving body driven by a driver,
determine whether or not the moving body is in a lost state set in advance based on the path information, and
generate and output route information that guides the moving body to a predetermined place when the moving body is determined to be in the lost state.

2. The information processing device according to claim 1, wherein:
the processor is configured to
acquire the path information as an input parameter and input the path information to a determination learning model, and
output whether or not the moving body in the path information is in the lost state as an output parameter of the determination learning model; and
the determination learning model is a learning model generated by machine learning using an input and output data set in which path information including information on movement paths of a plurality of moving bodies is used as an input parameter for learning and a determination result of whether or not path information is in the lost state is used as an output parameter for learning.

3. The information processing device according to claim 1, wherein the processor is configured to
acquire user information including information about the driver of the moving body, and
generate and output schedule information including a schedule when the driver drives on a movement path included in the route information based on the user information.

4. The information processing device according to claim 1, wherein the processor is configured to output information that notifies a user terminal of a user associated with the driver that the moving body is in the lost state when the moving body is determined to be in the lost state.

5. The information processing device according to claim 4, wherein the processor is configured to output the route information in the moving body to the user terminal.

6. The information processing device according to claim 4, wherein the processor is configured to
acquire user information including information about the driver of the moving body,
generate schedule information including a schedule when the driver moves on a movement path included in the route information based on the user information, and
output the schedule information to the user terminal.

7. The information processing device according to claim 1, wherein the processor is configured to output information that notifies an administrative server managed by an administration that the moving body is in the lost state when the moving body is determined to be in the lost state.

8. The information processing device according to claim 1, wherein the predetermined place is a place determined based on user information including information about the driver of the moving body.

9. The information processing device according to claim 1, wherein the moving body is configured to be drivable by a user of a predetermined age or older, and the driver is of the predetermined age or older.

10. An information processing system comprising:
a first device having a first processor configured to have hardware, which is provided in a moving body driven by a driver and acquires, from the moving body, and outputs moving body information about the moving body, path information about movement of the moving body, and user information about the driver; and
a second device having a second processor configured to have hardware, which acquires path information including information on a movement path of the moving body from the first device, determines whether or not the moving body is in a lost state set in advance based on the path information, and generates route information that guides the moving body to a predetermined place and outputs the route information to the first device when the moving body is determined to be in the lost state.

11. The information processing system according to claim 10, wherein:
the second processor is configured to
acquire the path information as an input parameter and input the path information to a determination learning model, and
output whether or not the moving body in the path information is in the lost state as an output parameter of the determination learning model; and
the determination learning model is a learning model generated by machine learning using an input and output data set in which path information including information on movement paths of a plurality of moving bodies is used as an input parameter for learning and a determination result of whether or not path information is in the lost state is used as an output parameter for learning.

12. The information processing system according to claim 10, wherein the second processor is configured to
acquire the user information from the first device, and
generate and output schedule information including a schedule when the driver drives on a movement path included in the route information based on the user information.

13. The information processing system according to claim 10, wherein the second processor is configured to output information that notifies a user terminal of a user associated with the driver that the moving body is in the lost state when the moving body is determined to be in the lost state.

14. The information processing system according to claim 13, wherein the second processor is configured to output the route information in the moving body to the user terminal.

15. The information processing system according to claim 13, wherein the second processor is configured to
acquire the user information from the first device,
generate schedule information including a schedule when the driver moves on a movement path included in the route information based on the user information, and
output the schedule information to the user terminal.

16. The information processing system according to claim 10, wherein the second processor is configured to output information that notifies an administrative server managed by an administration that the moving body is in the lost state when the moving body is determined to be in the lost state.

17. The information processing system according to claim 10, wherein the predetermined place is a place determined based on user information including information about the driver of the moving body.

18. The information processing system according to claim 10, wherein the moving body is configured to be drivable by a user of a predetermined age or older, and the driver is of the predetermined age or older.

19. A program causing a processor configured to have hardware to execute
acquiring path information including information on a movement path of a moving body driven by a driver;
determining whether or not the moving body is in a lost state set in advance based on the path information; and
generating and outputting route information that guides the moving body to a predetermined place when the moving body is determined to be in the lost state.

20. The program according to claim 19, the program causing the processor to execute
acquiring the path information as an input parameter and inputting the path information to a determination learning model, and
outputting whether or not the moving body in the path information is in the lost state as an output parameter of the determination learning model,
wherein the determination learning model is a learning model generated by machine learning using an input and output data set in which path information including information on movement paths of a plurality of moving bodies is used as an input parameter for learning and a determination result of whether or not path information is in the lost state is used as an output parameter for learning.
